(19) United States
(12) Patent Application Publication
(10) Pub. No.: US 2004/0029757 A1
(43) Pub. Date: Feb. 12, 2004

(54) Hand dishwashing detergent composition and methods for manufacturing and using

(75) Inventors: Mark D. Levitt, St. Paul, MN (US); Keith E. Olson, Apple Valley, MN (US); Lisa M. Sanders, Eagan, MN (US); Charles A. Hodge, Cottage Grove, MN (US)

Correspondence Address: MERCHANT & GOULD PC, P.O. BOX 2903, MINNEAPOLIS, MN, 55402-0903, US

(73) Assignee: Ecolab Inc.

(21) Appl. No.: 10/299,428

(22) Filed: Nov. 18, 2002

Related U.S. Application Data
(60) Provisional application No. 60/401,763, filed on Aug. 8, 2002.
(60) Provisional application No. 60/401,763, filed on Aug. 8, 2002.

(51) Int. Cl. C11D 17/00

(52) U.S. Cl. 510/235; 510/426

(57) ABSTRACT

A hand dishwashing detergent composition as provided according to the invention. The hand dishwashing detergent composition includes an anionic surfactant blend, a betaine surfactant, and water. The anionic surfactant blend includes a first anionic surfactant component and a second anionic surfactant component. The first anionic surfactant component can include at least one of an alkyl aryl sulfonate wherein the alkyl group contains 10 to about 18 carbon atoms and the aryl group comprises at least one of benzene, toluene, xylene, and a secondary alkane sulfonate wherein the alkane group includes about 10 to about 18 carbon atoms. The second anionic surfactant component includes at least one of:

an alkyl ether sulfate wherein the alkyl group contains 10 to about 18 carbon atoms;

alkyl methyl sulfate wherein the alkyl group contains about 10 to about 18 carbon atoms;

alkyl sulfate wherein the alkyl group contains about 10 to about 18 carbon atoms;

and alpha olefin sulfonate wherein the alpha olefin contains about 10 to about 18 carbon atoms. The betaine surfactant can have the following formula:

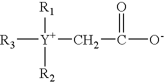

wherein:

y is N, S or P. Methods for manufacturing and using the hand dishwashing composition are described.

### CROSS REFERENCE TO RELATED APPLICATIONS

This application claims priority to U.S. Provisional Patent Application Serial No. 60/401,763 that was filed with the United States Patent and Trademark Office on Aug. 8, 2002. U.S. Provisional Patent Application Serial No. 60/401,763 is encorporated herein by reference.

### FIELD OF THE INVENTION

The invention relates to a hand dishwashing detergent composition, a method for manufacturing a hand dishwashing detergent composition, and a method for using a hand dishwashing detergent composition. In particular, the hand dishwashing detergent composition can be provided as a superconcentrate and diluted to form a concentrate detergent composition for sale to consumers. The concentrate detergent composition can be used to prepare a use solution for washing items in a sink including dishes, flatware, glasses, pots, pans, etc.

### BACKGROUND OF THE INVENTION

Hand dishwashing detergent compositions are widely available for washing dishware, flatware, glasses, pots, and pans. In general, it is desirable for hand dishwashing detergent compositions to exhibit sudsing and grease removal properties. Hand dishwashing detergent compositions are often provided as a liquid, concentrate that is squirted into a sink containing water and items to be washed.

Cocoa diethanol amide and the corresponding free amine are found in several commercially available dishwashing detergent compositions. There is concern that cocoa diethanol amide and/or the corresponding free amine may have potential harmful effects on humans. Accordingly, effort has been directed at providing a hand dishwashing detergent composition that does not include cocoa diethenol amide and/or the free amine.

Hand dishwashing detergent is available to consumers in retail stores provided as a liquid concentrate, typically provided in 16 to 32 ounce containers. The concentrate can be packaged by the detergent manufacturer, and then shipped in the packaged containers.

### SUMMARY OF THE INVENTION

A hand dishwashing detergent composition as provided according to the invention. The hand dishwashing detergent composition includes an anionic surfactant blend, a betaine surfactant, and water. The anionic surfactant blend includes a first anionic surfactant component and a second anionic surfactant component. The first anionic surfactant component can include at least one of an alkyl aryl sulfonate wherein the alkyl group contains 10 to about 18 carbon atoms and the aryl group comprises at least one of benzene, toluene, xylene, and a secondary alkane sulfonate wherein the alkane group includes about 10 to about 18 carbon atoms. The second anionic surfactant component includes at least one of:

an alkyl ether sulfate wherein the alkyl group contains 10 to about 18 carbon atoms;

alkyl methyl sulfate wherein the alkyl group contains about 10 to about 18 carbon atoms;

alkyl sulfate wherein the alkyl group contains about 10 to about 18 carbon atoms;

and alpha olefin sulfonate wherein the alpha olefin contains about 10 to about 18 carbon atoms. The betaine surfactant can have the following formula:

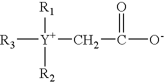

wherein:

y is N, S or P.

A method of forming a hand dishwashing use solution is provided according to the invention. The method includes steps of forming a superconcentrated dishwashing composition having a water concentration of less than about 35 wt. %, diluting the superconcentrated dishwashing composition to a concentrate containing between about 50 wt. % and about 98 wt. % water, packaging the concentrate into container sized for distribution to consumers, and introducing a portion of the concentrate into a sink comprising water and soiled articles.

A method for manufacturing a hand dishwashing detergent composition as provided by the invention. The method includes mixing the anionic surfactant blend, the betaine surfactant, and water to provide a detergent composition.

### DETAILED DESCRIPTION OF THE INVENTION

The hand dishwashing detergent composition can be provided in the form of a superconcentrated detergent composition that can be diluted to form a concentrate detergent composition. It is expected that the concentrate detergent composition will be used by squirting an amount of the concentrate detergent composition into a sink filled with water and items to be washed including dishes, flatware, glasses, pots, pans, etc. The resulting detergent composition that is foamy and is used to wash items can be referred to as the use solution. It should be understood that the names “detergent composition” and “composition” refer to the hand dishwashing detergent composition according to the invention and can be provided in the form of a superconcentrate, a concentrate, or a use solution unless the context makes it clear that reference is made to one form of the composition.

It is expected that the detergent composition will be available as a superconcentrate when shipped to retail distributors. The retail distributors will then dilute the superconcentrate to provide a concentrate, and then package the concentrate in a size convenient for customers to purchase from the retail distributors. The customers will then use the concentrate to form a use solution for hand washing various items in a sink similar to the way conventional hand dishwashing detergent compositions are used. By providing the detergent composition as a superconcentrate, it is expected that shipping and storage costs can be reduced. Retailers will be able to prepare the ready to concentrate from the superconcentrate when desired, and then package the concentrate for customers. It should be understood that the superconcentrate can be shipped to end users such as restaurants and hotels, and then diluted to a concentrate and used to prepare a use solution.

The superconcentrate can be provided with a water concentration that is sufficiently low that transportation and storage costs can be kept low, and then the superconcentrate can be diluted with water to a desired concentration for use as a hand dishwashing detergent composition. When the detergent composition is provided as a superconcentrate, the total water percent of the composition can be less than about 35 wt. %. When the detergent composition is provided as a concentrate, the total amount of water can be between about 50 wt. % and about 98 wt. %. When the detergent composition is provided as a use solution, it is expected that the use solution will have a solids content that is sufficient to provide the desired level of sudsing and detersive properties. In general, it is expected that the solids content of the use solution will be at least 100 ppm. Although there is no real upper limit on the solids content of the use solution since it is expected that a higher concentration will provide sudsing and detersive properties, it is expected that a solids content of greater than about 1,500 ppm may result in waste. It should be understood that the “solids content” refers to the non-water components of the composition.

The components of the detergent composition can be selected in that the composition can be provided as a stable superconcentrate and then diluted to a concentrate, and then further diluted and used as a use solution.

The detergent composition includes an anionic surfactant blend that provides a desired level of foaming and cleaning properties when diluted to a use solution. The anionic surfactant blend includes a first anionic surfactant component and a second anionic surfactant component. Each of the first anionic surfactant component and the second anionic surfactant component can include one or more anionic surfactants.

The first anionic surfactant component can include at least one of an alkyl aryl sulfonate and a secondary alkane sulfonate. The alkyl aryl sulfonate has an alkyl group that contains 10 to 18 carbon atoms and the aryl group can be at least one of benzene, toluene, and xylene. An exemplary alkyl aryl sulfonate includes linear alkyl benzene sulfonate. An exemplary linear alkyl benzene sulfonate includes linear dodecyl benzyl sulfonate that can be provided as an acid that is neutralized to form the sulfonate. The secondary alkane sulfonate can include an alkane group having 10 to 18 carbon atoms. An exemplary secondary alkane sulfonate includes sodium C₁₄-C₁₇ secondary alkyl sulfonate commercially available as Hostapur SAS from Clariant. The superconcentrate can include the secondary alkyl sulfonate component in an amount sufficient to provide desired foaming and cleaning properties.

The first anionic surfactant component can be provided in the superconcentrate in an amount sufficient to provide desired sudsing and detersive properties. In general, it is expected that the first anionic surfactant component will be provided in the superconcentrate with a range of between about 1 wt. % and about 70 wt. %, between about 15 wt. % and about 65 wt. %, between about 20 wt. % and about 35 wt. %, and between about 22 wt. % and about 30 wt. %. The first anionic surfactant component can include the alkyl aryl sulfonate alone, the secondary alkane sulfonate alone, or a mixture of the alkyl aryl sulfonate and the secondary alkane sulfonate. When provided as a mixture, it is expected that at least one of the alkyl aryl sulfonate and the secondary alkane sulfonate will be provided at a concentration of at least about 5 wt. % and the other component will be provided in an amount of at least about 10 wt. %.

The second anionic surfactant component can include at least one of an alkyl ether sulfate, an alkyl methyl ester sulfate, an alkyl sulfate, and an alpha olefin sulfonate. The alkyl ether sulfate includes an alkyl group containing 10 to 18 carbon atoms. The alkyl methyl ester sulfate includes an alky group containing 10 to 18 carbon atoms. The alkyl sulfate includes an alkyl group containing 10 to 18 carbon atoms. The alpha olefin sulfonate includes an alpha olefin containing 10 to 18 carbon atoms.

An exemplary alkyl ether sulfate includes sodium lauryl ether sulfate. The alkyl ether sulfate component can include an ethoxy group having between about 1 and about 5 repeating ethoxy groups. An exemplary alkyl ether sulfate is sodium lauric ether ethoxylate sulfate and is available under the name Steol CS-460. In general, the alkyl ether sulfate component provides a desired level of foaming property and is generally considered to be mild to skin. In addition, it is expected that the alkyl ethoxy sulfate component and the alkyl aryl sulfonate component can interact synergistically to enhance foaming and/or cleaning properties. In general, it is expected that the alkyl ethoxyl sulfate component, if included, will be provided in an amount of between about 2 wt. % and about 12 wt. %, and can be provided in an amount of between about 3 wt. % and about 8 wt. %.

Exemplary alkyl sulfates include sodium lauryl sulfate and sodium lauryl/myristyl sulfate. The sodium lauryl sulfate component can be provided in an amount of between about 0.5 wt. % and about 8 wt. %, and can be provided in an amount of between about 3 wt. % and about 7 wt. %.

The second anionic component can be provided in the superconcentrate in an amount of between 1 wt. % and about 70 wt. %, between about 4 wt. % and about 60 wt. %, between about 5 wt. % and about 30 wt. %, and between about 8 wt. % and about 15 wt. %. The second anionic surfactant component can be provided as a blend of the various surfactants. When provided as a blend, any of the surfactants can be provided in an amount of between about 1 wt. % and about 49 wt. %.

The anionic surfactant blend is provided in an amount sufficient to provide desired foaming and cleaning properties. It is expected that the superconcentrate will contain at least about 5 wt. % of the anionic surfactant blend. In addition, it is expected that the superconcentrate will contain up to about 75 wt. % of the anionic surfactant blend in order to provide room in the composition for additional components.

The anionic surfactants can be neutralized with an alkali metal salt, an alkaline earth salt, an amine, or a mixture thereof. Exemplary alkali metals include sodium and potassium. Exemplary amines include monoethanolamine, triethanolamine, and monoisopropanolamine. If a mixture of salts is used, the alkaline metal can be sodium and the alkaline earth metal can be magnesium, and the molar ratio of sodium to magnesium can be between about 3:1 and about 1:1.

Many of the concentration ranges are identified in the context of a superconcentrate containing less than about 35 wt. % water. It should be understood that the concentration ranges can be calculated, based upon the ranges for the superconcentrate, to provide ranges for a concentrate having a water concentration of between 50 wt. % and about 98 wt. %, and for a use solution containing a solids content of at least 100 ppm.

The detergent composition can include a betaine surfactant to provide enhanced grease removal and/or grease cutting properties.

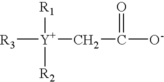

wherein:

Y is P, S, N, or a mixture thereof;

each of R₁, R₂, and R₃, is independent of each other, hydrogen, an alkyl group, an alkylene group, an aralkyl group, an aralkylene group, or an aryl group. Each of the alkyl groups, the alkylene groups, the aralkyl groups, the aralkylene groups, and the aryl groups can be: linear, branched, or cyclic; saturated or unsaturated; substituted or unsubstituted; containing or not containing heteroatoms; and containing at least one carbon atom. The groups can each contain 1 to 18 carbon atoms. The substituted groups can be hydroxyl, carbonyl, ester, amino, alkeynyl, amido, alkynyl, and halogen groups. The heteroatoms can be Si, O, N, S, and P.

Exemplary betaine surfactants that can be used according to the invention include alkyl amidopropyl betaine wherein the alkyl group contains between 8 and 18 carbon atoms. An exemplary alkyl amidopropyl betaine is cocoamidopropyl betaine.

The betaine surfactant can be provided in the superconcentrate in an amount between about 0.5 wt. % and about 15 wt. %, and can be between about 1 wt. % and about 5 wt. %.

The detergent composition can include an amphoteric (zwitterionic) surfactant. Amphoteric surfactants can contain both a cationic group and an anionic group at at least some pH. Exemplary amphoteric surfactants that can be used according to the invention include those containing both a quaternary ammonium group and an anionic group selected from sulfonate and carboxylate groups. The groups can include those groups that maintain their amphoteric character over most of the pH range of interest for cleaning. The sulfonate group is the normally preferred anionic group.

Exemplary amphoteric surfactants that can be used according to the invention include those having the formula:

R³—[C(O)—N(R⁴)—CR⁵₂)ₙ]ₘN(R⁶)₂(⁺)—(CR⁵₂)ₚ—Y(−)

wherein each R³ is an alkyl, or alkylene, group containing from about 8 to about 20 carbon atoms or from about 10 to about 18 carbon atoms or from about 10 to about 16 carbon atoms; each (R⁴) and (R⁶) is hydrogen, methyl, ethyl, propyl, hydroxy substituted ethyl or propyl and mixtures thereof; each (R⁵) is hydrogen and hydroxy groups; m is 0 or 1; and each n and p is a number from 1 to about 4, and can be about 3, there being no more than about one hydroxy group in any (CR⁵₂) moiety; and wherein each Y can be a carboxylate (COO—) or a sulfonate. The R³ groups can be branched and/or unsaturated. The amphoteric surfactant can be a surfactant that is not a betaine surfactant

Other amphoteric detergent surfactants are set forth at Col. 4 of U.S. Pat. No. 4,287,080, Siklosi, incorporated herein by reference. Another detailed listing of suitable amphoteric/zwitterionic detergent surfactants for the detergent compositions herein can be found in U.S. Pat. No. 4,557,853, Collins, issued Dec. 10, 1985, incorporated by reference herein. Commercial sources of such surfactants can be found in McCutcheon's EMULSIFERS AND DETERGENTS, North American Edition, 1984, McCutcheon Division, MC Publishing Company, incorporated herein by reference.

Exemplary amphoteric surfactants that can be used according to the invention include imidazoline derived amphoterics. Imidazoline derived amphoteric can be obtained by a ring opening reaction of an imidazoline group to provide an alkyl amphoacetate, an alkyl amphodiacetate, an alkyl amphoproprionate and alky amphodiproprionate. The alkyl group can contain between about 8 and about 18 carbon atoms. Exemplary imidazoline derived amphoterics include disodium cocoa amphodiproprionate.

The superconcentrate can include a non-betaine amphoteric surfactant in an amount of between 0.5 wt. % an about 10 wt. % and between about 2 wt. % and about 7 wt. %. It should be understood that this range of amphoteric surfactant applies to amphoteric surfactants in general and also to the imidazoline derived amphoteric.

The detergent composition can include a blend of betaine surfactant and amphoteric surfactant. The amphoteric surfactant blend can include an imidazoline derived amphoteric and an alkyl amidipropyl betaine.

The detergent composition can include a blend of the imidazoline derived amphoteric in an amount of between about 0.5 wt. % and about 30 wt. %, between about 3 wt. % and about 20 wt. %, and between about 5 wt. % and about 15 wt. % based on the weight of the superconcentrate. In addition, when the composition contains both imidazoline derived amphoteric and alkyl amidopropyl betaine, they can be provided at a weight ratio between about 8:1 to about 1:8 at a weight ratio of between about 4:1 and about 1:4, and at a weight ratio between about 2:1 and about 1:2. It should be understood that the imidazoline based amphoteric can be used without the alkyl amidopropyl betaine, and the alkyl amidopropyl betaine can be used without the imidazoline derived amphoteric. When the detergent composition contains the imidazoline derived amphoteric without the alkyl amidopropyl betaine, the imidazoline derived amphoteric can be provided at a weight ratio between about 0.5 wt. % and about 20 wt. %, and at a weight ratio between about 3 wt. % and about 20 wt. %. When the detergent composition contains the alkyl amidopropyl betaine without the imidazoline derived amphoteric, the alkyl amidopropyl betaine can be provided at a weight ratio between about 0.5 wt. % and about 20 wt. % and at a weight ratio of between about 3 wt. % and about 12 wt. %.

The detergent composition can include a divalent cation for enhancing grease cutting properties of the anionic surfactant blend and to provide viscosity modification. In general, the superconcentrate can include between about 0.1 wt. % and about 3 wt. % of the divalent cation, and can include between about 0.5 wt. % and about 2 w and about 2 wt. % of the divalent cation.

The detergent composition can include an organic solvent. The organic solvent can be an oxygenated organic solvent. Exemplary oxygenated organic solvents include polyols, ether alcohols, and alcohols. In general, polyols refer to components having two or more hydroxyl groups. Ether alcohols have at least one ether linkage and can include one or more hydroxyl groups. Alcohols can include one or more hydroxyl groups. Exemplary oxygenated organic solvents include propylene, glycol, glycerine, hexylene glycol, polyglycols, glycol ethers, and tripropylene ether. Exemplary glycol ethers include dipropylene glycol methyl ether, propylene glycol methyl ether, tripropylene glycol methyl ether, and tripropylene glycol butyl ether.

The superconcentrate can include an organic solvent in an amount sufficient to maintain a desired viscosity and/or to enhance cleaning properties. Organic solvents can be selected to include those that do not induce thickening during dilution. The superconcentrate can include at least about 3 wt. % organic solvent and can include up to about 25 wt. % organic solvent.

Divalent cations that can be used according to the invention include calcium, magnesium, zinc, cadmium, nickel, copper, cobalt, zirconium, chromium, and mixtures thereof. Preferred divalent cations include calcium, magnesium, and mixtures of calcium and magnesium. The divalent cations may be added in the form of salts, for example, as chloride, acetate, sulphate, formate and/or nitrate or as a complex metal salt. Exemplary calcium salts and magnesium salts include calcium chloride, magnesium chloride, magnesium acetate, magnesium sulphate, magnesium oxide, and mixtures thereof. Zinc can be provided as zinc chloride.

The detergent composition can include a hydrotrope to help solubilize the components of the composition. Exemplary hydrotropes include sodium xylene sulfonate, and any other hydrotrope known to one skilled in the art. Suitable hydrotropes include sodium, potassium, ammonium or water-soluble substituted ammonium salts of toluene sulfonic acid, naphthalene sulfonic acid, cumene sulfonic acid, xylene sulfonic acid. When the hydrotrope is included in the detergent composition, the superconcentrate can include between about 0.2 wt. % and about 5 wt. % of the hydrotrope, and between about 0.5 wt. % and about 2 wt. % of the hydrotrope.

The detergent composition can contain one or more enzymes which provide cleaning performance benefits. Said enzymes include enzymes selected from cellulases, hemicellulases, peroxidases, proteases, glucomylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof. A preferred combination is a detergent composition having a cocktail of conventional applicable enzymes like protease, amylase, lipase, cutinase and/or cellulase. When an enzyme is included in the detergent composition, it can be included at from about 0.0001% to about 5% of active enzyme by weight of the detergent composition.

It is also possible to include an enzyme stabilization system into the compositions of the present invention when any enzyme is present in the composition.

Perfumes and perfumery ingredients can be included in the detergent composition. Exemplary perfumes and perfumery ingredients include a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes typically comprise from about 0.01% to about 2%, by weight, of the detergent compositions herein, and individual perfumery ingredients can comprise from about 0.0001% to about 90% of a finished perfume composition.

Other perfume materials include essential oils, resinoids, and resins from a variety of sources including, but not limited to: Peru balsam, Olibanum resinoid, styrax, labdanum resin, nutmeg, cassia oil, benzoin resin, coriander and lavandin. Still other perfume chemicals include phenyl ethyl alcohol, terpineol, linalool, linalyl acetate, geraniol, nerol, 2-(1,1-dimethylethyl)cyclohexanol acetate, benzyl acetate, and eugenol. Carriers such as diethylphthalate can be used in the finished perfume compositions.

The detergent composition can include a chelating agent such as iron and/or manganese chelating agents. Such chelating agents can include amino carboxylates, amino phosphonates, polyfunctionally-substituted aromatic chelating agents and mixtures therein.

Amino carboxylates useful as optional chelating agents include ethylenediaminetetrace-tates, N-hydroxyethylethylenediaminetriacetates, nitrilotriacetates, ethylenediamine tetrapro-prionates, triethylenetetraaminehexacetates, diethylenetriaminepentaacetates, and ethanoldi-glycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylenediaminetetrakis (methylenephosphonates) as DEQUEST.

Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

An exemplary biodegradable chelator for use herein is ethylenediamine disuccinate (“EDDS”), especially the [S,S] isomer described in U.S. Pat. No. 4,704,233, Nov. 3, 1987, to Hartman and Perkins.

The compositions herein may also contain water-soluble methyl glycine diacetic acid (MODA) salts (or acid form) as a chelant or co-builder. Similarly, the so called “weak” builders such as citrate can also be used as chelating agents.

If utilized, these chelating agents can be provided at from about 0.1% to about 15% by weight of the detergent compositions herein. More preferably, if utilized, the chelating agents will comprise from about 0.1% to about 3.0% by weight of such compositions.

The detergent composition can be subjected to acidic stresses created by food soils when put to use, i.e., diluted and applied to soiled dishes. If a composition with a pH greater than 7 is desired, the composition can include a buffering agent capable of providing a generally more alkaline pH in the composition and in the dilute solutions, i.e., about 0.1% to 0.4% by weight aqueous solution, of the composition. The pKa value of this buffering agent can be about 0.5 to 1.0 pH units below the desired pH value of the composition (determined as described above). The pKa of the buffering agent can be from about 7 to about 10. Under these conditions the buffering agent most effectively controls the pH while using the least amount thereof.

The buffering agent may be an active detergent in its own right, or it may be a low molecular weight, organic or inorganic material that is used in this composition solely for maintaining an alkaline pH. Preferred buffering agents for compositions of this invention are nitrogen-containing materials. Some examples are amino acids such as lysine or lower alcohol amines like mono, di-, and tri-ethanolamine. Other preferred nitrogen-containing buffering agents are Tri (hydroxymethyl)amino methane (HOCH₂)₃CNH₃ (IRIS), 2-amino-2-ethyl-1,3-propanediol, 2-amino-2-methylpropanol, 2-amino-2-methyl-1,3-propanol, disodium glutamate, N-methyl diethanolamide, 1,3-diamino-propanol N,N′-tetra-methyl-1,3-diamino-2-propanol, N,N-bis(2-hydroxyethyl)glycine (bicine) and N-tris (hydroxymethyl) metbyl glycine (tricine). Mixtures of any of the above are also acceptable. Useful inorganic buffers/alkalinity sources include the alkali metal carbonates and alkali metal phosphates, e.g., sodium carbonate, sodium polyphosphate. For additional buffers see McCutcheon's EMULSIFIERS AND DETERGENTS, North American Edition, 1997, McCutcheon Division, MC Publishing Company Kirk and WO 95/07971 both of which are incorporated herein by reference.

The buffering agent, if used, can be present in the composition at a level of from about 0.1% to 15%, from about 1% to 10%, and from about 2% to 8%, by weight of the composition.

The detergent composition can include one or more detersive adjuncts selected from the following: soil release polymers, polymeric dispersants, polysaccharides, abrasives, bactericides, tarnish inhibitors, builders, enzymes, dyes, buffers, antifungal or mildew control agents, insect repellents, perfumes, opacifiers, hydrotropes, thickeners, processing aids, suds boosters, brighteners, anti-corrosive aids, stabilizers antioxidants and chelants. A wide variety of other ingredients useful in detergent compositions can be included in the compositions herein, including other active ingredients, carriers, hydrotropes, antioxidants, processing aids, dyes or pigments, solvents for liquid formulations, solid fillers for bar compositions, etc. If high sudsing is desired, suds boosters such as the C₁₀₋₁₄ alkanolamides can be incorporated into the compositions, typically at 1%-10% levels. The C₁₀₋₁₆ monoethanol amide illustrate a typical class of such suds boosters. Use of such suds boosters with high sudsing adjunct surfactants such as the amine oxides, betaines and sultaines noted above is also advantageous.

An antioxidant can be optionally added to the detergent compositions of the present invention. They can be any conventional antioxidant used in detergent compositions, such as 2,6-di-tert-butyl4-methylphenol (BE), carbamate, ascorbate, thiosulfate, monoetbanolamine (MA), diethanolamine, triethanolamine, etc. It is preferred that the antioxidant, when present, be present in the composition from about 0.001% to about 5% by weight.

Various detersive ingredients employed in the present compositions optionally can be further stabilized by absorbing said ingredients onto a porous hydrophobic substrate, then coating said substrate with a hydrophobic coating. Preferably, the detersive ingredient is admixed with a surfactant before being absorbed into the porous substrate. In use, the detersive ingredient is released from the substrate into the aqueous washing liquor, where it performs its intended detersive function.

To illustrate this technique in more detail, a porous hydrophobic silica (trademark SIPERNAT D10, DeGussa) is admixed with a proteolytic enzyme solution containing 3%-5% of C₁₃₋₁₅ ethoxylated alcohol (EO 7) nonionic surfactant. Typically, the enzyme/surfactant solution is 2.5× the weight of silica. The resulting powder is dispersed with stirring in silicone oil (various silicone oil viscosities in the range of 500-12,500 can be used). The resulting silicone oil dispersion is emulsified or otherwise added to the final detergent matrix. By this means, ingredients such as the aforementioned enzymes, bleaches, bleach activators, bleach catalysts, photoactivators, dyes, fluorescers, fabric conditioners and hydrolyzable surfactants can be “protected” for use in detergents, including liquid laundry detergent compositions.

The superconcentrate can be packaged and transported to another facility, such as a retail store, for dilution to provide a concentrate that can be packaged and sold to consumers. The superconcentrate can be provided in totes. Exemplary totes can be available in sizes ranging from about 1 liter to about 500 gallons, or about 55 gallons to about 500 gallons. An exemplary size range is from about 5 gallons to about 55 gallons. It is expected that consumers will generally desire to purchase a concentrate in a container size that is convenient for them to take home and use for washing articles in a sink. An exemplary size convenient for consumers is generally provided within the range of about 16 fluid ounces and about 700 fluid ounces, and can be between about 16 fluid ounces and about 150 fluid ounces.

It should be understood that the detergent composition according to the invention can be free of cocoa diethanol amide and its corresponding amine (diethynolamine). In general, this means that if the detergent composition contains any cocoa diethanol amide or diethynolamine, it is preferably present in an amount of less than about 1 wt. %. Even more preferably, there is no amount of cocoa diethanol amide or diethynolamine in the detergent composition.

### EXAMPLE 1

A superconcentrate is prepared having the following formula:

TABLE 1
Superconcentrate

| Component | Weight % |
|---|---|
| Propylene Glycol Tech. | 15.66 |
| Linear Dodecyl Benzyl Sulfuric Acid 96% | 28.19 |
| 2-Amino, 2-Methyl, 1-Propanol | 8.71 |
| Lauryl Dimethylamine Oxide 30% | 15.59 |
| Sodium Lauric Ether Ethoxylate Sulfate 60% | 5.85 |
| Sodium Lauryl Sulfate 93% | 6.89 |
| Cocoa Amido Propyl Betaine | 9.43 |
| Cocoampodropionate-Amphoteric Imidazoline | 4.19 |
| Magnesium Chloride 30% Tech. | 4.16 |
| Sodium Xylene Sulfanate 40% | 1.05 |
| Neolone M-50 | 0.06 |
| Green Apple Fragrance | 0.21 |
| Pylaklor Brillian Green LX-6391A | 0.01 |

The superconcentrate is diluted with water equivalent to 87.5 wt. % to provide a concentrate. The concentrate can be squirted into a sink containing water and items to be washed in an amount sufficient to provide a desired level of sudsing and cleaning properties. In general, it is expected that a desired amount of sudsing and cleaning properties can be provided when about 0.25 ounce of the concentrate is introduced into about 1 gallon water.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A hand dishwashing detergent composition comprising:
(a) an anionic surfactant blend comprising a first anionic surfactant component and a second anionic surfactant component, wherein:
(1) the first anionic surfactant component comprises at least one of:
(i) alkyl aryl sulfonate wherein the alkyl group comprises about 10 to about 18 carbon atoms and the aryl group comprises at least one of benzene, toluene, and xylene;
(ii) secondary alkane sulfonate wherein the alkane group comprises about 10 to about 18 carbon atoms; and
(2) the second anionic surfactant component comprises at least one of:
(i) alkyl ether sulfate wherein the alkyl group contains about 10 to about 18 carbon atoms
(ii) alkyl methyl ester sulfate wherein the alkyl group contains about 10 to about 18 carbon atoms;
(iii) alkyl sulfate wherein the alkyl group contains about 10 to about 18 carbon atoms; and
(iv) alpha olefin sulfonate wherein the alpha olefin contains about 10 to about 18 carbon atoms;
(b) a betaine surfactant having the formula: 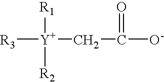
wherein:
Y is N, S, or P; and
each of R₁, R₂, and R₃ is, independent of each other, hydrogen, alkyl, alkylene, aralkyl, aralkylene, or aryl; and
(c) water.

2. A hand dishwashing detergent composition according to claim 1, wherein the anionic surfactant blend comprises the alkyl aryl sulfonate and the alkyl ether sulfate.

3. A hand dishwashing detergent composition according to claim 2, wherein the anionic surfactant blend further comprises the alkyl sulfate.

4. A hand dishwashing detergent composition according to claim 1, wherein the composition comprises about 15 wt. % to about 65 wt. % of the first anionic surfactant component and about 4 wt. % to about 60 wt. % of the second anionic surfactant component.

5. A hand dishwashing detergent composition according to claim 1, wherein the composition contains less than about 1 wt. % cocoa diethanol amide or corresponding free amine.

6. A hand dishwashing detergent composition according to claim 1, further comprising an amphoteric surfactant.

7. A hand dishwashing detergent composition according to claim 1, further comprising an imidazoline derived amphoteric.

8. A hand dishwashing detergent composition according to claim 7, wherein the imidazoline derived amphoteric surfactant comprise at least one of alkyl amphoacetate, alkyl amphodiacetate, alkyl amphoproprionate, and alkyl amphodiproprionate.

9. A hand dishwashing detergent composition according to claim 1, further comprising a divalent cation.

10. A hand dishwashing detergent composition according to claim 1, further comprising an organic solvent comprising at least one hydroxyl group.

11. A hand dishwashing detergent composition according to claim 10, wherein the organic solvent comprises at least one of propylene glycol and glycerine.

12. A hand dishwashing detergent composition according to claim 1, wherein the composition comprises less about 35 wt. % water.

13. A hand dishwashing detergent composition according to claim 1, wherein the detergent composition comprises between about 50 wt. % and about 98 wt. % water.

14. A hand dishwashing detergent composition according to claim 1, wherein the detergent composition comprises a mixture of an imidazoline derived amphoteric surfactant and the alkyl amidopropyl betaine, wherein the ratio of immidazoline derived amphoteric and alkyl amidopropyl betaine is between about 8:1 and about 1:8.

15. A hand dishwashing detergent composition according to claim 1, wherein the detergent composition comprises at least about 5 wt. % of the anionic surfactant blend.

16. A hand dishwashing detergent composition according to claim 1, wherein the secondary alkyl sulfonate comprises linear dodecyl benzyl sulfonate.

17. A hand dishwashing detergent composition according to claim 1, wherein the alkyl ethoxyl sulfate comprises sodium laurel ethoxyl sulfate.

18. A method of forming a hand dishwashing use solution, the method comprising steps of:
(a) forming a superconcentrated dishwashing composition having a water concentration of less than about 35 wt. %;
(b) diluting the superconcentrated dishwashing composition to a concentrate containing between about 50 wt. % and about 98 wt. % water;
(c) packaging the concentrate into containers sized for distribution to consumers; and
(d) introducing a portion of the concentrate into a sink comprising water and soiled articles.

19. A method according to claim 18, wherein the step of forming a superconcentrated dishwashing composition occurs at a first location, and the steps of diluting the superconcentrated dishwashing composition and packaging the concentrate occur at a second location, wherein the first location and the second location are provided at different facilities.

20. A method according to claim 18, wherein the second location comprises a retail store for distribution of packaged concentrate.

21. A method according to claim 18, wherein the containers have a size of between about 16 fluid ounces and about 700 fluid ounces.

22. A method according to claim 18, wherein the second location comprises a retail store that sells the concentrate provided in containers to consumers.

23. A method according to claim 18, wherein the soiled article comprises at least one of dishes, flatware, glasses, pots, and pans.

24. A method of manufacturing a hand dishwashing detergent composition, the method comprising mixing:
(a) an anionic surfactant blend comprising a first anionic surfactant component and a second anionic surfactant component, wherein:
(1) the first anionic surfactant component comprises at least one of:
(i) alkyl aryl sulfonate wherein the alkyl group comprises about 10 to about 18 carbon atoms and the aryl group comprises at least one of benzene, toluene, and xylene;
(ii) secondary alkane sulfonate wherein the alkane group comprises about 10 to about 18 carbon atoms; and
(2) the second anionic surfactant component comprises at least one of:
(i) alkyl ether sulfate wherein the alkyl group contains about 10 to about 18 carbon atoms
(ii) alkyl methyl ester sulfate wherein the alkyl group contains about 10 to about 18 carbon atoms;
(iii) alkyl sulfate wherein the alkyl group contains about 10 to about 18 carbon atoms; and
(iv) alpha olefin sulfonate wherein the alpha olefin contains about 10 to about 18 carbon atoms;
(b) a betaine surfactant having the formula: 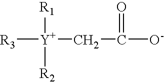
wherein:
Y is N, S, or P; and
each of R₁, R₂, and R₃ is, independent of each other, hydrogen, alkyl, alkylene, aralkyl, aralkylene, or aryl; and
(c) water.
